(19) United States
(12) Patent Application Publication
(10) Pub. No.: US 2019/0114552 A1
(43) Pub. Date: Apr. 18, 2019

(54) METHOD FOR SIMULATING THE THERMO-FLUID DYNAMIC BEHAVIOR OF MULTIPHASE FLUIDS IN A HYDROCARBONS PRODUCTION AND TRANSPORT SYSTEM

(71) Applicant: ENI S.p.A., Rome (IT)

(72) Inventors: Alberto Giulio DI LULLO, Tribiano (IT); Axel TUROLLA, Villafranca Padovana (IT); Massimo ZAMPATO, Salzano (IT)

(73) Assignee: ENI S.p.A., Rome (IT)

(21) Appl. No.: 16/091,021

(22) PCT Filed: Apr. 3, 2017
(86) PCT No.: PCT/EP2017/057900

§ 371 Date: Oct. 3, 2018

(30) Foreign Application Priority Data
Apr. 4, 2016 (IT) 102016000034302

(51) Int. Cl. G06N 7/00; G06F 17/50; E21B 43/00

(52) U.S. Cl. CPC G06N 7/00; G06F 2217/16; E21B 43/00; G06F 17/5018

(57) ABSTRACT

Simulation method (100) for simulating the thermo-fluid dynamic behavior of multiphase fluids in a hydrocarbons production and transport system, said method comprising the following steps: outlining (110) the hydrocarbons production and transport system as a plurality of interconnected component blocks, thus creating a schematic representation; modeling (120) each component block with a simplified analytical mathematical model selected from the group of models comprising at least one conduit model, a valve model, a reservoir model and a separator model, each simplified analytical mathematical model comprising a plurality of constitutive equations adapted to describe the thermo-fluid dynamic behavior of the corresponding component block; generating (130) an oriented graph on the basis of the schematic representation; determining (140) a plurality of topological equations on the basis of the oriented graph; determining (150) a plurality of output variables adapted to describe the thermo-fluid dynamic behavior of the system by solving the set of the plurality of topological equations and of the constitutive equations.

The present invention relates to a method for simulating the thermo-fluid dynamic behavior of multiphase fluids in a hydrocarbons production and transport system in a multiplicity of operating conditions, such as closing or reopening the line, reducing or increasing the flow rate, the fluid cooling process.

In the present disclosure, reference shall be made, in particular, to systems that carry the hydrocarbons extracted from wells to the inlet of the distribution network.

However, the simulation method of the present invention can also be applied to the distribution network.

Currently, simulating the thermo-fluid dynamic behavior of multiphase hydrocarbons through thermo-fluid dynamic simulators that solve the Navier-Stokes equations by finite volume discretization methods is known.

These finite volume thermo-fluid dynamic simulators have good reliability, but they also present a sizable computational cost which determines high simulation times, which grow as complexity and the dimensions of the analyzed system grow.

Simulation times are critical during the studies for the development of a hydrocarbon production and distribution system, design steps in which it can be extremely useful to very rapidly identify potentially critical situations for the productive life of the system.

An object of the present invention is to overcome the aforementioned drawbacks and in particular to devise a method for simulating the thermo-fluid dynamic behavior of multiphase fluids in a hydrocarbons production and transport system that is able to obtain reliable results, while entailing requiring shorter simulation times than prior art finite volume thermo-fluid dynamic simulators.

This and other objects according to the present invention are achieved by a method for simulating the thermo-fluid dynamic behavior of multiphase fluids in a hydrocarbons production and transport system according to claim 1.

Additional characteristics of the method for simulating the thermo-fluid dynamic behavior of multiphase fluids in a hydrocarbons production and transport system are the subject of the dependent claims.

The characteristics and advantages of a method for simulating the thermo-fluid dynamic behavior of multiphase fluids in a hydrocarbons production and transport system according to the present invention shall become more readily apparent from the following exemplifying and non-limiting description, referred to the accompanying schematic drawings in which:

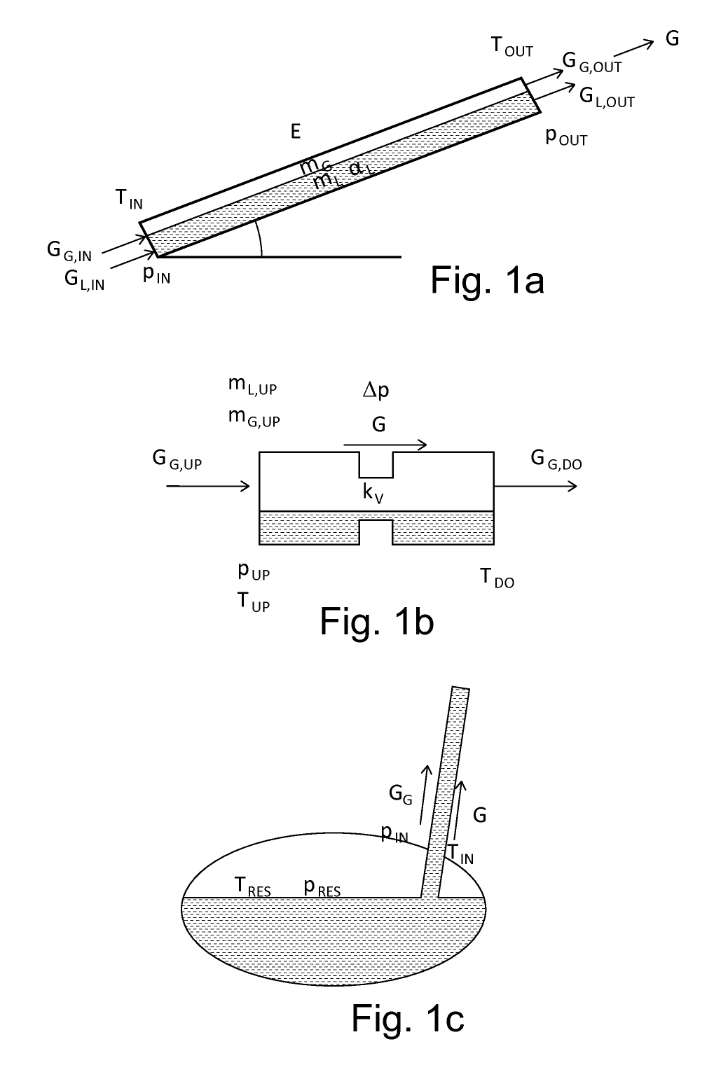

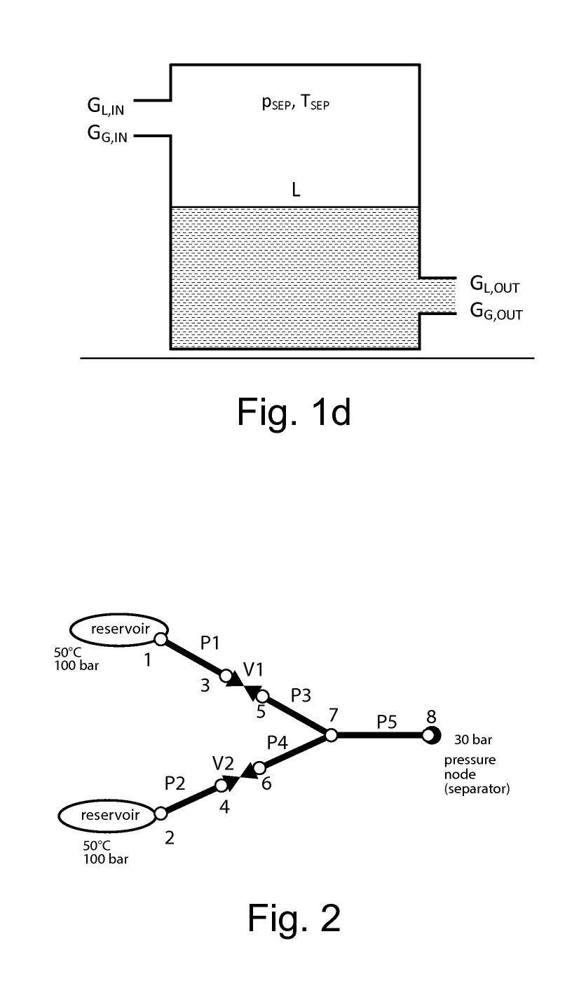

FIG. 1a is a schematic view representing a component block of a hydrocarbons production and transport system modeled according to a simplified conduit model;

FIG. 1b is a schematic view representing a component block of a hydrocarbons production and transport system modeled according to a simplified valve model;

FIG. 1c is a schematic view representing a component block of a hydrocarbons production and transport system modeled according to a simplified reservoir model;

FIG. 1d is a schematic view representing a component block of a hydrocarbons production and transport system modeled according to a simplified separator model;

FIG. 2 is a schematic representation of a hydrocarbons production and transport system to be simulated;

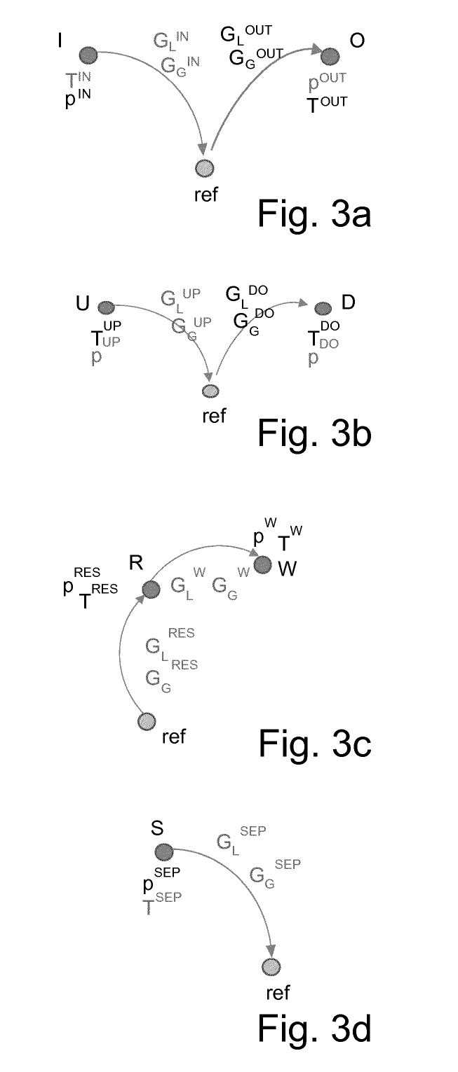

FIGS. 3a, 3b, 3c and 3d are four elements of an oriented graph that represent respectively a conduit, a valve, a reservoir and a separator;

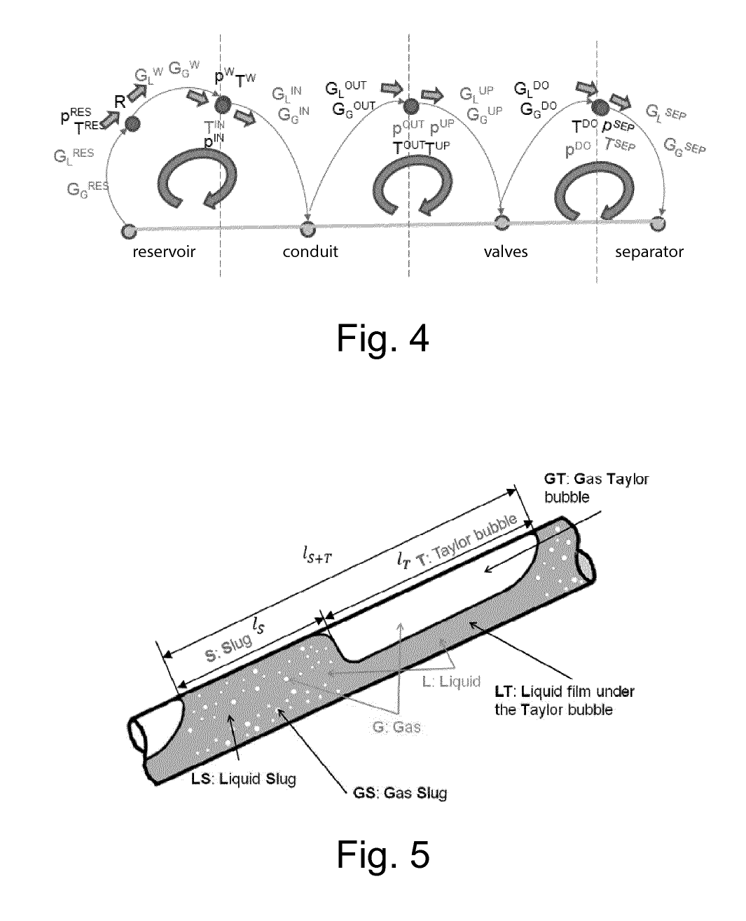

FIG. 4 is an oriented graph that represents the series connection of a reservoir, a well and a valve;

FIG. 5 is a schematic view representative of a conduit in slug flow regime;

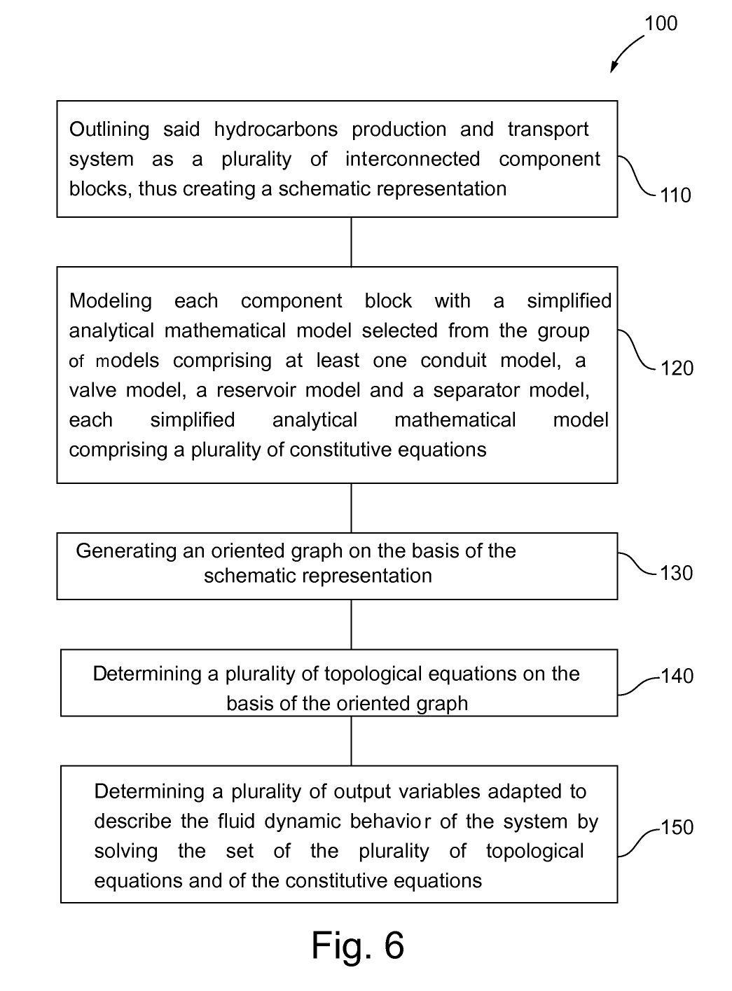

FIG. 6 is a flow chart that represents a method for the simulation of the thermo-fluid dynamic behavior of multiphase fluids in a hydrocarbons production and transport system according to the present invention;

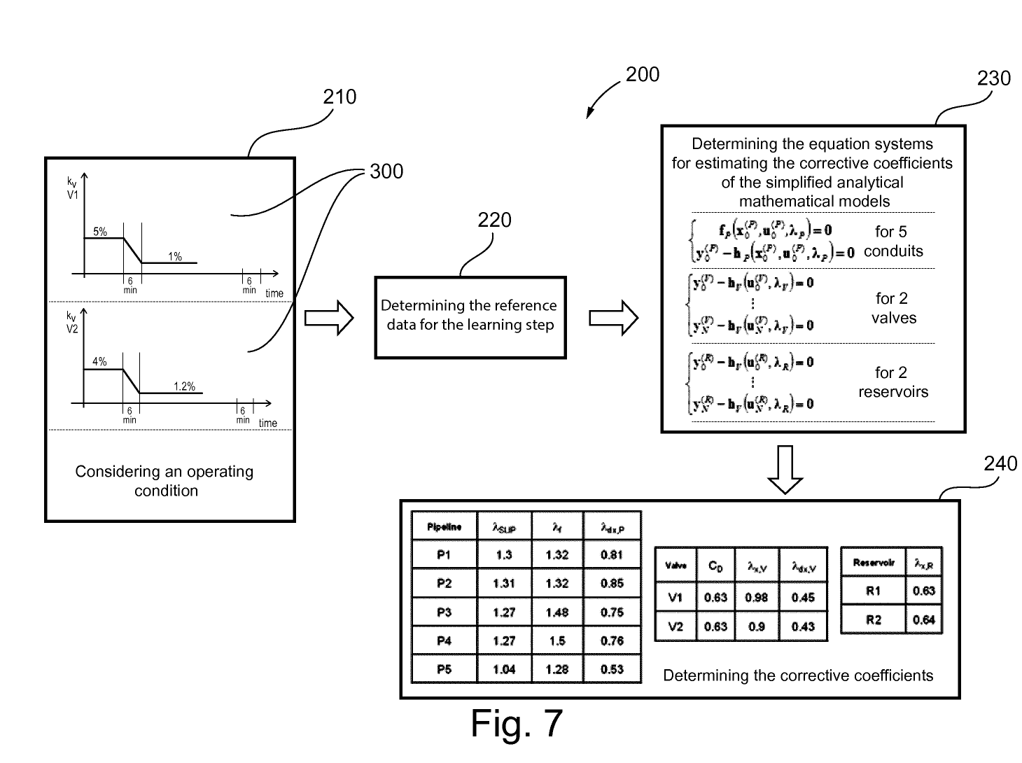

FIG. 7 is a schematic block diagram that illustrates a learning step of simplified analytical mathematical models of the corresponding component blocks of the system of FIG. 2;

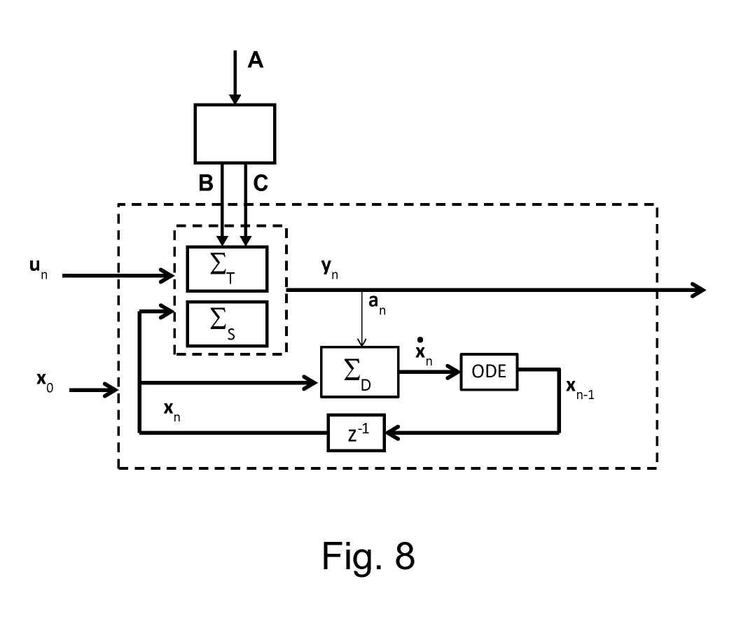

FIG. 8 is a schematic block diagram representing a resolution step in the method for the simulation of the thermo-fluid dynamic behavior of multiphase fluids in a hydrocarbons production and transport system of FIG. 4;

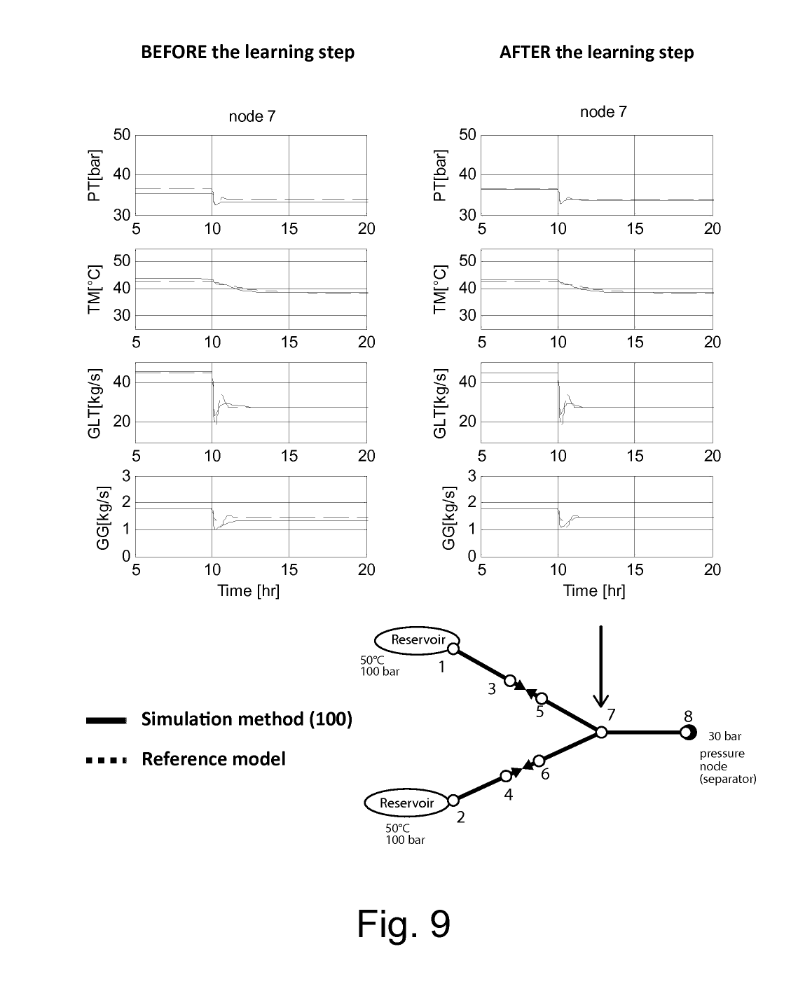

FIG. 9 shows a plurality of charts that show the trend over time of pressure (PT), temperature (TM), mass flow rate of liquid (GLT) and gas (GG), calculated at a node of the system of FIG. 2 by the simulation method according to the present invention (solid line) and by a prior art finite volume thermo-fluid dynamic simulator (dashed line); in particular, the charts on the left are obtained before the learning step of the simplified analytical mathematical models, while the charts on the right are obtained after the learning step of the simplified models.

With reference to the figures, a simulation method is shown for simulating the thermo-fluid dynamic behavior of multiphase fluids in a hydrocarbons production and transport system, indicated in its entirety with the number 100.

Said simulation method 100 comprises an initial step 110 in which the transport system is outlined as a plurality of interconnected component blocks thus obtaining a schematic representation such as the one shown in FIG. 2. Each component block is then modeled 120 according to a simplified analytical mathematical model selected from the group of models comprising at least one conduit model, a valve model, a reservoir model, a separator model.

The system shown in FIG. 2, for example, comprises two reservoirs G1 and G2 with related wells P1 and P2 and wellhead valves V1 and V2; from said valves originate two conduits P3 and P4 that join a third conduit P5, which ends in a constant pressure node (e.g. the inlet of a separator).

It is stressed that each of the two wells P1 and P2 of the two reservoirs was modeled according to the simplified conduit model.

Each of these simplified analytical mathematical models is represented by a plurality of constitutive equations adapted to describe the thermo-fluid dynamic behavior of the corresponding component block. In particular, the constitutive equations describe the evolution of a plurality of variables between inlet and outlet of the individual component block, as well as the evolution of these variables over time; the simulation method of the present patent is able to describe the characteristic transients in the operational scenarios described above.

The aforesaid variables are, for example, the flow rates of the different phases, the pressures, the temperatures and so on.

Preferably, the modeling step 120 further comprises the step in which for each simplified analytical mathematical model a plurality of corrective coefficients is applied to the constitutive equations, where the corrective coefficients are estimated so as to adapt the results obtained from the simplified analytical mathematical model to reference data. These reference data can be, in particular, derived from actual field measurements or from known finite volume thermo-fluid dynamic simulators.

The corrective coefficients are defined in such a way as to assume a value equal to 1 in case of perfect agreement between the simplified analytical mathematical model and the reference date. Therefore, greater discrepancies or inadequacies of the simplified model relative to the reference date are expressed by the progressive departure of the corrective coefficients from the unitary value.

In modelling the discrete elements of the system, it must be considered that the conduit element and the separator element are dynamic elements, i.e. provided with memory, whereas the reservoir element and the valve element are static, i.e. without memory.

In the present description, the subscript L refers to a liquid, the subscript G refers to a gas, the subscript M refers to a liquid-gas mixture, the subscript IN refers to an inlet, the subscript OUT refers to an outlet, the subscript UP refers to the upstream side of a valve, the subscript DO refers to the downstream side of a valve, the subscript RES refers to a reservoir, the subscript W refers to a well, the subscript V refers to a valve, the subscript P refers to a conduit (“pipeline”), the subscript SEP refers to a separator. Preferably, the simplified analytical mathematical conduit model can comprise the following constitutive equations:
two mass conservation equations, one for the liquid phase and one for the gaseous phase:

$${\dot{m}}_{L} = - \frac{1}{Δ L } ( {m}_{L} {v}_{L , OUT} - {m}_{L 0} - {v}_{L , IN} ) - {ψ}_{G}$$

$${\dot{m}}_{G} = - \frac{1}{Δ L} ( {m}_{G} {v}_{G , OUT} - {m}_{G 0} {v}_{G , IN} ) + {ψ}_{G}$$

where m_{L} indicates the mass of liquid per unit of volume, m_{G} indicates the mass of gas per unit of volume, m_{L0} indicates the mass of liquid per unit of volume in the previous conduit, m_{G0} indicates the mass of gas per unit of volume in the previous conduit, ΔL indicates the length of the conduit, v_{L,IN} and v_{L,OUT} indicate the velocity of the liquid respectively at the inlet and at the outlet, v_{G,IN} and v_{G,OUT} indicate the velocity of the gas respectively at the inlet and at the outlet, ψ_{G} indicates the mass flow rate per unit of volume that changes from the liquid phase to the gaseous phase.
a total momentum conservation equation (describes both phases):

$${\dot{G}}_{OUT} = - \frac{A}{Δ L} ( {m}_{L} {v}_{L , OUT}^{2} - {m}_{L} {v}_{L , IN}^{2} + {m}_{G 0} {v}_{G , OUT}^{2} - {m}_{G 0} {v}_{G , IN}^{2} ) - \frac{A}{Δ L} ( {p}_{OUT} - {p}_{IN} ) - A Γ - AR$$

where Gₒᵤₜ indicates the mass flow rate out, A indicates the cross section area of the conduit, ΔL indicates the length of the conduit, v_{L,IN} and v_{L,OUT} indicate the velocity of the liquid respectively in and out, v_{G,IN} and v_{G,OUT} indicate the velocity of the gas respectively in and out, m_{L} indicates the mass of liquid per unit of volume, m_{G} indicates the mass of gas per unit of volume, m_{L0} indicates the mass of liquid per unit of volume in the previous conduit, m_{G0} indicates the mass of gas per unit of volume in the previous conduit, Γ indicates the head loss per unit of length (which depends on the flow regime), R indicates the friction loss per unit of length (which depends on the flow regime), pᵢₙ and pₒᵤₜ indicate the pressure respective at the inlet and at the outlet.
a total energy E conservation equation (describes both phases):

$$\dot{E} = - \frac{1}{Δ L} [ {m}_{L} {v}_{L , OUT} ( {h}_{L} + \frac{{v}_{L}^{2}}{2} + {gz}_{OUT} ) - {m}_{L 0} {v}_{L , IN} ( {h}_{L 0} + \frac{{v}_{L , IN}^{2}}{2} = {gz}_{IN} ) ] - \frac{1}{Δ L} [ + {m}_{G} {v}_{G , OUT} ( {h}_{G} + \frac{{v}_{G , OUT}^{2}}{2} + {gz}_{OUT} ) - {m}_{G 0} {v}_{G , IN} ( {h}_{G 0} + \frac{{v}_{G , IN}^{2}}{2} + {gz}_{IN} ) ] - \frac{S}{A} U ( {T}_{OUT} - {T}_{ext} )$$

where m_{L} indicates the mass of liquid per unit of volume, m_{G} indicates the mass of gas per unit of volume, m_{L0} indicates the mass of liquid per unit of volume in the previous conduit, m_{G0} indicates the mass of gas per unit of volume in the previous conduit, ΔL indicates the length of the conduit, v_{L,IN} and v_{L,OUT} indicate the velocity of the liquid respectively in and out, v_{G,IN} and v_{G,OUT} indicate the velocity of the gas respectively in and out, A indicates the cross section area of the conduit, ΔL indicates the length of the conduit, S indicates the perimeter of the section of the conduit, U indicates the relative heat transfer coefficient of the walls of the conduit (including the insulation layers), Tₒᵤₜ and Tₑₓₜ indicate the temperature respectively at the outlet and external, g indicates the acceleration due to gravity, h_{L} and h_{G} indicate the specific enthalpy, respectively, of the liquid and of the gas, h_{L0} and h_{G0} indicate the specific enthalpy in the previous conduit respectively of the liquid of the gas, zᵢₙ and zₒᵤₜ indicate, respectively, the elevation of the inlet and of the outlet of the conduit relative to a reference level;
an equation that describes the evolution of pressure (describes both phases) obtained from the combination of the two mass conservation equations:

$${\dot{p}}_{IN} = {[ \frac{{α}_{L}}{{ρ}_{L}} \frac{\partial {ρ}_{L}}{\partial p} + \frac{1 - {α}_{L}}{{ρ}_{G}} \frac{\partial {ρ}_{G}}{\partial p} - ( \frac{1}{{ρ}_{G}} - \frac{1}{{ρ}_{L}} ) ( {m}_{L} + {m}_{G} ) \frac{\partial {x}_{G}}{\partial p} ]}^{- 1} [ - \frac{1}{Δ L {ρ}_{L}} ( {m}_{L} {v}_{L , OUT} - {m}_{L 0} {v}_{L , IN} ) - \frac{1}{Δ L {ρ}_{G}} ( {m}_{G} {v}_{G , OUT} - {m}_{G 0} {v}_{G , IN} ) + ( \frac{1}{{ρ}_{G}} - \frac{1}{{ρ}_{L}} ) {\tilde{ψ}}_{G} ]$$

where m_{L} and m_{G} indicate the mass per unit of volume respectively of liquid and of gas, m_{L0} and m_{G0} indicate the mass per unit of volume in the previous conduit respectively of liquid and of gas, v_{L,IN} and v_{L,OUT} indicate the velocity of the liquid respectively in and out, v_{G,IN} and v_{G,OUT} indicate the velocity of the gas respectively in and out, p indicates pressure, ΔL indicates the length of the conduit, ρ_{L} and ρ_{G} indicate the density respectively of the liquid and of the gas, x_{G} indicates the quality of the gas, \tilde{ψ}_{G} indicates a flow rate per unit of volume obtained from the mass flow rate per unit of volume ψ_{G} defined above, α_{L} indicates volume percent of liquid.

Using a single momentum conservation equation instead of two distinct ones for each phase, it is necessary to introduce an algebraic relationship to take into account the difference in velocity (“slip”) between the two phases. Therefore, in addition to the aforementioned equations for each flow regime (stratified, dispersed bubble, slug, etc.), the simplified conduit model can also comprise the following equations:
an equation that defines the terms R that take into account, in the momentum conservation equation, the frictions of the fluid with the walls of the conduit and between the different phases (R);
an equation that defines the terms T that take into account, in the momentum conservation equation, hydraulic head losses;
a slip equation.

For example, for the stratified regime the following equations are considered:
equation defining the friction loss per unit of length R:

$$R = {R}_{L} + {R}_{G} , \begin{matrix}{R}_{L} = \frac{1}{2 A} {f}_{L} {ρ}_{L} \vert {v}_{L} \vert {v}_{L} {S}_{L} \\ {R}_{G} = \frac{1}{2 A} {f}_{G} {ρ}_{G} \vert {v}_{G} \vert {v}_{G} {S}_{G}\end{matrix}$$

where R_{L} and R_{G} indicate the friction losses respectively of the liquid phase and of the gaseous phase, A indicates the cross section area of the conduit, f_{L} and f_{G} indicate the friction coefficients respectively of liquid and of gas, ρ_{L} and ρ_{G} indicate respectively the densities of liquid and of gas, v_{L} and v_{G} indicate respectively the velocities of liquid and of gas, S_{L} and S_{G} indicate the parts of circumference of the section of the conduit that are “wet” respectively by liquid and by gas;
equation defining the head loss per unit of length Γ

$$Γ = ( {m}_{L} + {m}_{G} ) g sin θ$$

where m_{L} and m_{G} indicate the mass per unit of volume respectively of liquid and of gas, g indicates the acceleration due to gravity, θ indicates the inclination of the conduit relative to the horizontal;
slip equation:

$$\frac{{R}_{I}}{{α}_{L} ( 1 - {α}_{L} )} - \frac{{R}_{G}}{1 - {α}_{L}} + \frac{{R}_{L}}{{α}_{L}} - ( {ρ}_{L} - {ρ}_{G} ) g sin θ = 0$$

where R_{L} and R_{G} indicate the friction losses respectively of the liquid and gaseous phase, R_{I} indicates the friction loss between the two phases, g indicates the acceleration due to gravity, θ indicates the inclination of the conduit relative to the horizontal, ρ_{L} and ρ_{G} indicate the density respectively of the liquid and of the gas, u_{L} indicates the volume percent of liquid.

For the bubbly regime, the following equations are considered:
equation defining the friction loss per unit of length R:

$$R = \frac{1}{2 A} {f}_{M} {ρ}_{M} {v}_{M} \vert {v}_{M} \vert π D$$

where A indicates the cross section area of the conduit, f_{M} indicates the friction coefficient of the liquid-gas mixed phase, ρ_{M} indicates the density of the liquid-gas mixture, ν_{M} indicates the velocity of the fluid, D indicates the diameter of the conduit;
equation defining the head loss per unit of length Γ

$$Γ = ( {m}_{L} + {m}_{G} ) g sin θ$$

where m_{L} and m_{G} indicate the mass per unit of volume respectively of liquid and of gas, g indicates the acceleration due to gravity, θ indicates the inclination of the conduit relative to the horizontal;
slip equation:

$${v}_{G} - {v}_{L} - {1.18 [ \frac{g σ ( {ρ}_{L} - {ρ}_{G} )}{{ρ}_{L}^{2}} ]}^{\frac{1}{4}} sin θ = 0$$

ν_{L} and ν_{G} indicate the velocities respectively of liquid and of gas, g indicates the acceleration due to gravity, θ indicates the inclination of the conduit relative to the horizontal, ρ_{L} and ρ_{G} indicate the density respectively of the liquid and of the gas, σ indicates the surface tension of the liquid.

For the slug regime, the following equations are considered:
equation defining the friction loss per unit of length R:

$$R = {R}_{S} + {R}_{T} = \frac{1}{2 A} {f}_{S} {ρ}_{S} {v}_{M} \vert {v}_{M} \vert S \frac{{l}_{S}}{{l}_{S + T}} + \frac{1}{2 A} ( {f}_{GT} {ρ}_{G} \vert {v}_{GT} \vert {v}_{GT} {S}_{GT} ) \frac{{l}_{T}}{{l}_{S + T}}$$

where R_{S} and R_{T} indicate the friction losses in the “slug” section and in the “Taylor bubble” section of the slug unit, A indicates the section of the conduit, f_{S} and f_{GT} indicates the friction coefficients of the fluid in the “slug” and “Taylor bubble” sections, ρ_{S} and ρ_{G} indicate the densities of the fluid respectively in the “slug” and in the gas section, v_{M} and v_{GT} indicate the velocities of the fluid and respectively in the “slug” section and of the gas contained in the “Taylor bubble”, S and S_{GT} indicate respectively the circumference of the section of the conduit and the part of circumference “wet” by the gas of the “Taylor bubble”, l_{S} the length of the “slug” section and l_{T} the length of the “Taylor bubble” section, l_{s+T} indicates the total length of the slug unit;
equation defining the head loss per unit of length Γ

$$Γ = \frac{{ρ}_{S} {l}_{S} + {ρ}_{T} {l}_{T}}{{l}_{S + T}} g sin θ$$

where g indicates the acceleration due to gravity, θ indicates, ρ_{S} and ρ_{T} indicate the density respectively in “slug” regime and in “Taylor bubbly” regime, l_{S} the length of the “slug” section, l_{T} indicates the length of the “Taylor bubbly” section, l_{S+T} indicates the total length of the slug unit;
slip equation:

v_{G}−C_{0T}v_{M}−v_{0T}=0

where C_{0T} is a flow distribution coefficient and v_{0T} is the velocity of a gas bubble that rises along a conduit of stagnating liquid (v_{L}=0).

As corrective coefficients can be selected, for example, multiplicative coefficients that correct:
the slip equation;
the friction component;
   the derivative of gas quality with respect to pressure.

In particular, for the stratified regime, the λ_{S} coefficient is inserted in the slip equation as follows:

$$\frac{{λ}_{S} {R}_{I}}{{α}_{L} {α}_{G}} - \frac{{R}_{G}}{{α}_{G}} + \frac{{R}_{L}}{{α}_{L}} ( {ρ}_{L} - {ρ}_{G} ) sin ϑ = 0$$

where R_{L} and R_{G} indicate the friction losses respectively of the liquid and gaseous phase, R_{I} indicates the friction loss between the two phases, α_{L} and α_{G} indicate the volume percentages respectively of liquid and of gas, g indicates the acceleration due to gravity, θ indicates the inclination of the conduit relative to the horizontal, ρ_{L} and ρ_{G} indicate the density respectively of the liquid and of the gas.

For the bubbly regime, the λ_{S} coefficient is inserted in the slip equation as follows:

$${v}_{G} - {λ}_{S} \{ {v}_{L} + {1.18 [ \frac{g σ ( {ρ}_{L} - {ρ}_{G} )}{{ρ}_{L}^{2}} ]}^{\frac{1}{4}} sin ϑ \} = 0$$

ν_{L} and ν_{G} indicate the velocities respectively of liquid and of gas, g indicates the acceleration due to gravity, θ indicates the inclination of the conduit relative to the horizontal, ρ_{L} and ρ_{G} indicate the density respectively of the liquid and of the gas.

For the slug regime, the λ_{S} coefficient is inserted in the slip equation as follows:

v_{G}−λ_{S}C_{0T}v_{M}−V_{0T}=0

where v_{G} is the velocity of the gas, v_{M} the velocity of the fluid, C_{0T} is a flow distribution coefficient and v_{0T} is the velocity of a gas bubble that rises along a conduit of stagnating liquid (vL=0).

The corrective coefficient λ_{f} is multiplied times the friction coefficient of the liquid phase f_{L} in case of stratified regime, times the friction coefficient of the mixed liquid-gas phase f_{M} in case of “bubbly”, times the friction coefficient of the “slug” phase fs regime in case of “slug” regime.

The corrective coefficient λ_{dx,P} is multiplied times the derivative of gas quality with respect to pressure

$$\frac{\partial {x}_{G}}{\partial p} ( p , T ) .$$

The simplified conduit model can thus be written in state-space representation:

\dot{x}_{P}=f_{P}(x_{P},u_{P};λ_{P})

y_{P}=h_{P}(x_{P},u_{P};λ_{P});

where u_{P} is the vector of the “forcing” variables, e.g.:
outlet pressure p_{OUT};
inlet temperature T_{IN};
mass flow rate of the liquid at the inlet G_{G,IN};
mass flow rate of the gas at the inlet G_{G,IN};

x_{P} is the vector of the state variables, e.g.:
input pressure p_{IN};
internal energy of the fluid in the conduit element per unit of volume E;
total mass flow rate at the outlet G_{OUT};
mass of liquid in the conduit element per unit of volume m_{L};
mass of gas in the conduit element per unit of volume m_{G};

y_{P} is the variable output vector, e.g.:
inlet pressure p_{IN};
outlet temperature T_{OUT};
mass flow rate of the liquid at the outlet G_{L,OUT};
mass flow rate of the gas at the outlet G_{G,OUT};
average hold-up of the conduit or volume percent of liquid α_{L}, i.e. the ratio between the volume of liquid contained and the total volume of the conduit.

λ_{P} is the vector containing the aforementioned corrective multiplicative coefficients.

Preferably, the simplified analytical mathematical valve model can comprise the following constitutive equations:
an equation that ties the total mass flow rate to the pressure drop across the valve; one possible model is the Perkins model, known to persons skilled in the art;

$$G = {f}_{V} ( {p}_{TH} ) = {A}_{TH} \sqrt{{gp}_{UP} ρ \frac{{η ( 1 - \frac{{p}_{TH}}{{p}_{UP}} )}^{\frac{n - 1}{n}} + φ ( 1 - \frac{{p}_{TH}}{{p}_{UP}} )}{{[ 1 - {( \frac{{A}_{TH}}{{A}_{UP}} )}^{2} {( \frac{{x}_{G} + φ}{{{x}_{G} ( \frac{{p}_{TH}}{{p}_{UP}} )}^{- \frac{1}{n}} + φ} )}^{2} ] [ {{x}_{G} ( \frac{{p}_{TH}}{{p}_{UP}} )}^{- \frac{1}{n}} + φ ]}^{2}}}$$

where A_{TH} is the section area of the throat of the valve, A_{UP} is the section of the valve inlet, p_{TH} and pᵤₚ indicate the pressure respectively at the throat and at the inlet of the valve, x_{G} indicates gas quality, n indicates the polytropic expansion exponent, Φ and η are parameters related to the mass percentages of liquid and gas, G indicates the total mass flow rate that traverses the valve and ρ indicates the density of the fluid;
an equation that ties the mass flow rate of gas downstream and the mass flow rate of gas upstream;

$${G}_{G , DO} = {G}_{G , UP} + {A}_{UP} {ξ}_{G}$$

$${ξ}_{G} = - \frac{\partial {x}_{G}}{\partial p} {\vert}_{DO} Δ p \frac{{G}_{G , UP}}{{A}_{UP} {m}_{L , UP}} ( {m}_{L , UP} + {m}_{G , DO} )$$

where G_{G,UP} and G_{G,DO} indicate the mass flow rates of gas respectively at the inlet and at the outlet of the valve, A_{UP} is the inlet section area of the valve, [symbol] indicates the mass flow rate of gas that becomes liquid per unit of surface area, m_{L,UP} and m_{L,DO} indicates the liquid mass per unit of volume respectively at the inlet and at the outlet of the valve, p indicates pressure, Δp indicates the pressure difference between the inlet and the outlet of the valve;
an equation that describes the temperature interval between upstream and downstream T_{DO}.

$${T}_{DO} \text{:} {x}_{G , UP} {h}_{G , UP} + ( 1 - {x}_{G , UP} ) {h}_{L , UP} = {x}_{G , DO} {h}_{G , DO} + ( 1 - {x}_{G , DO} ) {h}_{L , DO}$$

where x_{G,UP} and x_{G,DO} indicate gas quality respectively at the inlet and at the outlet of the valve, h_{L,UP} and h_{L,DO} indicate the specific enthalpy of the liquid respectively at the inlet and at the outlet of the valve, h_{G,UP} and h_{G,DO} indicate the specific enthalpy of the gas respectively at the inlet and at the outlet of the valve.

As corrective coefficients can be selected, for example, multiplicative coefficients C_{D}, λ_{x,V}, λ_{∂x,V} that correct:
the total mass flow rate G (in fact, the corrective coefficient is the “discharge coefficient”, known to the persons skilled in the art); in this case, the following correspondence applies G→C_{D}G;
gas quality x_{G}, a function of pressure p and of temperature T; in this case, the following correspondence applies x_{G}(p,T)→λ_{x,V}x_{G}(p,T);
the derivative of gas quality with respect to pressure xG, a function of pressure p and of temperature T; in this case, the following correspondence applies

$$\frac{\partial {x}_{G}}{\partial p} ( p , T ) \to {λ}_{\partial x , V} \frac{\partial {x}_{G}}{\partial p} ( p , T ) ;$$

The simplified valve model can then be written in representation in the following way:

y_{V}=h_{V}(u_{V};λ_{V})

where u_{V} is the vector of the “forcing” variables, e.g.:
pressure loss between upstream and downstream Δp;
upstream pressure p_{UP};
upstream temperature T_{UP};
mass flow rate of the upstream gas G_{G,UP};
liquid mass in the upstream conduit element (or in the reservoir) per unit of volume m_{L,UP};
gas mass in the upstream pipeline (or in the reservoir) per unit of volume m_{G,UP};
percentage of valve opening k_{V},

y_{V} is the variable output vector, e.g.:
total mass flow rate G
mass flow rate of the downstream gas G_{G,DO}
downstream temperature T_{DO}.

λ_{V} is the vector containing the aforementioned corrective coefficients.

Preferably, the simplified analytical mathematical reservoir model can comprise the following constitutive equations:
an equation that ties the total mass flow rate G to the difference between static pressure and inflow pressure:

G=ϕ_{IRP}(p_{RES}−p_{W})

where Φ_{IPR( )} is a function that represents the IPR curve known to the persons skilled in the art, p_{RES} and p_{W} indicates respectively the pressure in the reservoir and in the well;
an equation that describes the mass flow rate of gas G_{G} as a function of the total mass flow rate G:

G_{G}=R_{S,RES}G

where R_{S,RES} indicates the mass flow rate percentage of gas in the reservoir;
an equation that describes the temperature interval between the reservoir and the inlet of the well T_{IN}.

T_{IN}:x_{G,RES}h_{G,RES}+(1−x_{G,RES})h_{L,RES}=x_{G,W}h_{G,W}+(1−x_{G,W})h_{L,W},

where x_{G,RES} and x_{G,W} indicates gas quality respectively in the reservoir and in the well, h_{L,RES} and h_{L,W} indicate the specific enthalpy of the liquid respectively in the reservoir and in the well, h_{G,RES} and h_{G,W} indicate the specific enthalpy of the gas respectively in the reservoir and in the well.

As corrective coefficients can be selected, for example, a single multiplicative coefficient λ_{x,R} which corrects gas quality x_{G} as a function of pressure p and of temperature T; in this case, the following correspondence applies x_{G}(p,T)→λ_{x,R}x_{G}(p,T).

The simplified reservoir model can then be written in representation in the following way:

y₂=h_{R}(u_{R};λ_{R})

where u_{R} is the vector of the “forcing” variables, e.g.:
static pressure of the reservoir p_{RES},
inflow pressure p_{w},
temperature of the reservoir T_{RES},

y_{R} is the variable output vector, e.g.:
total mass flow rate G
mass flow rate of gas G_{G}
temperature at the inlet of the well T_{W},

λ_{R} is the aforementioned corrective coefficient.

Preferably, the simplified analytical mathematical separator model can comprise the following constitutive equations:
an equation that ties the mass flow rate of liquid at the outlet G_{L,OUT} to the mass flow rate of liquid at the inlet G_{L,IN}:

$${G}_{L , OUT} = \{ \begin{matrix}{G}_{L , IN} & {G}_{L , IN} < {G}_{DRAIN} AND {V}_{L} = 0 \\ {G}_{DRAIN} & {G}_{L , IN} \geq {G}_{DRAIN} OR {V}_{L} > 0\end{matrix}$$

where G_{DRAIN} indicates the maximum drain rate of the separator;
an equation that ties the mass flow rate of gas at the outlet G_{G,OUT} to the mass flow rate of gas at the inlet G_{G,IN}:

G_{G,OUT}=G_{G,IN}
an equation that describes the volume of liquid V_{L} inside the separator:

$${\dot{V}}_{L} = \frac{{G}_{L , IN} - {G}_{L , OUT}}{{ρ}_{L}}$$

where G_{L,IN} and G_{L,OUT} are respectively the mass flow rate of liquid flowing in and out and ρ_{L} is the density of the liquid at the separation conditions of temperature T_{SEP} and pressure p_{SEP}.

As corrective coefficients can be selected, for example, a single multiplicative coefficient λ_{ρ,Sep} which corrects the density of the liquid gas ρ_{L} as a function of the pressure and of the temperature at the separator.

The simplified separator model can then be written in representation in the following way:

\dot{x}_{S}=f_{S}(x_{S},u_{S};λ_{S})

y_{S}=h_{S}(x_{S},u_{S};λ_{S})

where u_{S} is the vector of the “forcing” variables, e.g.:
separation pressure p_{SEP},
separation temperature T_{SEP},
mass flow rate of liquid flowing in G_{L,IN},
mass flow rate of gas flowing in G_{G,IN},

y_{S} is the variable output vector, e.g.:
mass flow rate of liquid flowing out G_{L,OUT},
mass flow rate of gas flowing out G_{G,OUT}.
internal volume of liquid V_{L},

x_{S} is a state variable coinciding with one of the outputs, i.e. the volume of liquid V_{L},

λ_{S} is the aforementioned corrective coefficient.

The constitutive equations of the above simplified analytical mathematical models are derived from fluid dynamics law that are known in themselves; the parameters and the variables contained in these equations can be calculated in a known manner.

As stated above, the corrective coefficients of each simplified model are estimated in such a way as to adapt the results obtained by the model to reference date.

For this purposes, the step of modeling the component blocks 120 preferably comprises a learning step 200 in which the corrective coefficients are estimated for each simplified model for at least one stationary or transient flow regime (stratified, dispersed bubbly, slug and so on) and/or for at least one stationary or transient heat regime.

This learning step 200 can be carried out with different mathematical methods for the minimization of the discrepancy between the data obtained from the simplified model and the reference data.

For example, the least squares method can be used, considering as reference data the values of interest of pressure, temperature, flow rates, etc. measured in the field or calculated by means of finite volume thermo-fluid dynamic simulators.

Let y_{X} and u_{X} be the vectors of the reference data to be used respectively as reference output variables and forcing variables of the simplified model X.

Consider the case in which the simplified model X is the one relating to a conduit; in this case x_{P} is the vector of state variables of reference, which can be calculated starting from y_{P} and u_{P} with an equation

x_{P}=φ_{P}(y_{P},u_{P}).

The system to be solved with the least squares technique to estimate the corrective coefficients λ_{P} of the conduit model is for example

$$\{ \begin{matrix}{f}_{P} ( {x}_{P} ( {t}_{0} ) , {u}_{P} ( {t}_{0} ) ; {λ}_{P} ) = 0 \\ {y}_{P} ( {t}_{0} ) - {h}_{P} ( {x}_{P} ( {t}_{0} ) , {u}_{P} ( {t}_{0} ) ; {λ}_{P} ) = 0\end{matrix}$$

where t₀ is an instant in stationary state conditions. Solving the system indicated above is equivalent to imposing that, at the instant t₀, the state x_{P} is stationary and that the output variables of the simplified model are equal to the reference variables (measured or simulated with a reference model).

Let us consider the case in which the simplified model X is the one relating to a valve.

The system to be solved with the least squares technique to estimate the corrective coefficients λ_{V} of the valve model is for example

$$\{ \begin{matrix}{y}_{V} ( {t}_{0} ) - {h}_{V} ( {u}_{V} ( {t}_{0} ) ; {λ}_{V} ) = 0 \\ \begin{matrix}⋮ \\ {y}_{V} ( {t}_{N} ) - {h}_{V} ( {u}_{V} ( {t}_{N} ) ; {λ}_{V} ) = 0\end{matrix}\end{matrix}$$

where t₀ . . . t_{N} is the sequence of instants belonging to the time interval of interest. Solving the system indicated above is equivalent to imposing that the output variables of the simplified model are equal to the reference variables (measured or simulated).

Let us consider the case in which the simplified model X is the one relating to a reservoir.

The system to be solved with the least squares technique to estimate the corrective coefficients λ_{R} of the valve model is for example

$$\{ \begin{matrix}{y}_{R} ( {t}_{0} ) - {h}_{R} ( {u}_{R} ( {t}_{0} ) ; {λ}_{R} ) = 0 \\ {y}_{R} ( {t}_{N} ) - {h}_{R} ( {u}_{R} ( {t}_{N} ) ; {λ}_{R} ) = 0\end{matrix}$$

where t₀ . . . t_{N} is the sequence of instants belonging to the time interval of interest. Solving the system indicated above is equivalent to imposing that the output variables of the simplified model are equal to the reference variables (measured or simulated).

Consider the case in which the simplified model X is the one relating to a separator.

The system to be solved with the least squares technique to estimate the corrective coefficients λ_{S} of the separator model is for example

$$\{ \begin{matrix}{y}_{S} ( {t}_{0} ) - {h}_{S} ( {x}_{S} ( {t}_{0} ) , {u}_{S} ( {t}_{0} ) ; {λ}_{S} ) = 0 \\ \begin{matrix}⋮ \\ {y}_{S} ( {t}_{N} ) - {h}_{S} ( {x}_{S} ( {t}_{N} ) , {u}_{S} ( {t}_{N} ) ; {λ}_{S} ) = 0\end{matrix}\end{matrix}$$

where t₀ . . . t_{N} is the sequence of instants belonging to the time interval of interest. Solving the system indicated above is equivalent to imposing that the output variables of the simplified model are equal to the reference variables (measured or simulated).

FIG. 7 is a schematic representation of the learning step 200 relating to the simplified analytical mathematical models used to describe the system shown in FIG. 2. In particular, in an exemplifying manner, FIG. 7 relates to a learning step 200 carried out for the slug regime. This learning step 200 comprises considering 210 a particular operating condition, e.g. the one represented by the charts 300. This operating conditions corresponds to a sudden reduction in flow rate, obtained by partially closing both wellhead valves (turn down), in accordance with the curves of the charts 300. For this operating condition, the reference data for learning are determined 220 performing a simulation by means of a known finite volume thermo-fluid dynamics simulator or carrying out measurements in the field. Thereafter, the equation systems are determined 230 and solved 240 to estimate the corrective coefficients λ_{P} of the conduit model, the corrective coefficients λ_{V} of the valve model, the corrective coefficients λ_{R} of the reservoir model on the basis of the previously obtained reference data. In particular, the equation systems for estimating the corrective coefficients λ_{P} of the conduit model are as many as the component blocks modeled as a conduit; in the example in FIG. 7 they are five. Similarly, the equation systems for estimating the corrective coefficients λ_{V} of the valve model are as many as are the component blocks modelled as a valve, two in the example in FIG. 7; lastly, the equation systems for estimating the corrective coefficients λ_{R} of the valve model are as many as are the component blocks modeled as a valve, two in the example in FIG. 7. Solving 240 the aforesaid equation systems equations, the set of corrective coefficients λ_{P}, λ_{V}, λ_{R} are obtained.

In any case, the simulation method can comprise estimating the corrective coefficients for each flow and/or thermal regime, selecting as a reference the one corresponding to corrective coefficients that more closely approach the unit.

As stated above, a production and transport system can be described by a schematic representation like the one in FIG. 2.

The simulation method 100, according to the present invention, advantageously comprises a step in which an oriented graph is generated 130 on the basic of the aforesaid schematic representation. An example of oriented graph is shown in FIG. 4 and it relates to a series connection between a reservoir, a well and a valve.

The graph presents a plurality of edges j, a plurality of nodes I and a plurality of loops k. The loop are the cyclical paths of the graph, or a set of adjacent edges in which the last edge ends in the node from which the first one starts. It can be demonstrated that their number is M−N+1, where M is the number of edges and N the number of nodes.

To each node I is associated a set of scalar values, e.g. values of pressure, temperature or mass of liquid or gas per unit of volume.

To each edge j is associated a set of pairs of scalar values:
a flow ξⱼ, which can be a value of mass flow rate; the orientation of the individual edge j matches the direction of the flow ξⱼ;
a gradient ψⱼ, obtained from the difference between the corresponding scalar values of the connected nodes, e.g. a difference in pressure, in temperature, and so on.

These quantities are not equal in each point of the conduit and of the valve, therefore they can only be associated to inlets and outlets thereof.

Each edge j represents a component block of the set comprising at least the following blocks:
a reservoir in zero flow conditions similar to a “generator” of imparted pressure and temperature;
the IPR of the reservoir i.e. the relationship between flow rate and pressure at the inlet of a well;
the inlet of a conduit or of a well;
the outlet of a conduit or of a well;
the inlet of a valve;
the outlet of a valve;
the inlet of a separator;
the outlet of a separator.

Each edge j, with the exception of those representing the IPR of the reservoir, connects one of the nodes I of the graph to an individual reference node (ref) which has no corresponding “physical” node in the system and to which are associated zero values of pressure, temperature and so on. In this way, each edge has a uniquely defined gradient ψ. This mathematical representation provides the algebraic instruments to write in analytical matrix form the relations of continuity of multiphase flow rate, of pressure, of temperature, etc. described below.

The simulation method 100 thus comprises a topological description step in which the topology of the system is described 140 by means of a set of topological equations derived from the aforementioned oriented graph and called topological system Σ_{T}.

In particular, in the first place a first incidence matrix A=[aᵢⱼ] is generated that has as many rows as are the nodes of the graph and as many columns as are the edges of the graph. In detail, the element aᵢⱼ=1 if there is an edge that connects the nodes i and j; otherwise, the element aᵢⱼ=0.

From the first incidence matrix A is obtained a second incidence matrix B=[bᵢⱼ] and a loop matrix C=[cₖⱼ].

In detail, the second incidence matrix takes into account the orientation of the edges of the graph and therefore the element bᵢⱼ=1 if the flow ξⱼ is flowing out of the i^{th} node, the element bᵢⱼ=−1 if the flow ξⱼ is flowing into the i^{th}, bᵢⱼ=0 if aᵢⱼ=0.

Once the second incidence matrix B is obtained, it is possible to write the equations Bξ=0 that impose the continuity of the mass flow rates of the liquid and gaseous phases at each node.

With regard to the loop matrix C, the element cₖ₁=1 if the flow ξⱼ is oriented like the k^{th} loop, the element cₖⱼ=−1 if the flow ξⱼ is not oriented like the k^{th} loop, cₖⱼ=0 if the vertex j is not part of the loop k.

With the loop matrix C it is possible to write the equations at the loops Cψ=0, which impose the continuity of pressure, temperature and mass of the liquid and gaseous phases at each node of the system.

The set of equations:

$$\{ \begin{matrix}B ξ = 0 \\ C ψ = 0 \end{matrix}$$

is indicated as topological system Σ_{T}. The set of equations of the simplified models of valves, reservoirs and separators and of the non-differential equations of the simplified conduit models is indicated as static system Σ_{S}. The set of differential equations of the simplified conduit models is indicated as thermo-fluid dynamic system Σ_{D}.

The simulation method 100 according to the present invention, thus, comprises the step of solving 150 the complete system of equations comprising the plurality of topological equations and of the constitutive equations. The variables obtained by solving the aforesaid equations describe the thermo-fluid dynamic behavior of the production and transport system to be investigated.

Preferably, the step of solving 150 the complete system of equations can be represented schematically as shown in FIG. 8 and it comprises the use of an ODE (Ordinary Differential Equation) solver for solving the differential equations of the thermo-fluid dynamic system Σ_{D}.

In detail, consider that xₙ is the set of state variables of all the conduits at the generic instant tₙ, uₙ is the set of forcing variables and boundary conditions of the system at the same instant tₙ, i.e.
pressures and temperatures at the separators
static pressures of the reservoirs
temperatures of the reservoirs
percentage of opening of the valves.

The ODE solver performs the step-by-step numerical integration of the time derivative of the state variables tₙ₊₁, calculating the state variables at the next instant:

$${x}_{n + 1} = {x}_{n} + {\int }_{{t}_{n}}^{{t}_{n + 1}} {f}_{N} [ x ( t ) , u ( t ) ; Λ ] dt \qquad ( 1 )$$

where f_{N}( ) is the set of all equations of the static system Σ_{S}, of the thermo-fluid dynamic system Σ_{D} and of the topological system Σ_{T} and Λ is the set of corrective coefficients of all the simplified models.

The complete system f_{N}( ) comprises “stiff” equations, i.e. whose numeric resolution with explicit integration methods is unstable. Therefore, a possible ODE solver that provides a good compromise between calculation rapidity and accuracy is the Trapezoidal Rule with the 2^{nd} order Backward Differentiation Formula, i.e. an implicit method that provides a first trapezoidal step and a second “2^{nd} order backward differentiation” step, methodologies known in themselves to the persons skilled in the art.

The step-by-step integration carried out by the ODE solver expressed by the equation (1) needs, at the first step, knowledge of the initial state x₀. Preferably, the initial state x₀ is estimated imposing that said initial state x₀ be a system equilibrium state, i.e.

f_{N}(x₀,u₀;Λ)=0

The step of solving 150 the complete system of equations, with reference to FIG. 8, preferably comprises the following operations:
solving the system (Σ_{T}, Σ_{S}) i.e. the topological system Σ_{T} and the static system Σ_{S} considering as inputs the forcing variables uₙ and the state variables xₙ calculated at the n^{th} step and obtaining the output variables yₙ;
among the output variables, selecting the auxiliary variables aₙ which are the following:
   pressure at the outlets of the conduits p_{OUT};
   liquid mass flow rate at the inlets of the conduits G_{L,IN};
   liquid mass flow rate at the inlets of the conduits G_{G,IN};
   temperatures at the inlets of the conduits T_{IN};
solving the thermo-fluid dynamic system Σ_{D} by means of the ODE solver considering as inputs the auxiliary variables aₙ and the state variables xₙ at the n^{th} step.

FIG. 9 shows an exemplifying comparison of the results obtainable by the simulation method 100 according to the present invention and by a known reference finite volume thermo-fluid dynamic model illustrated by way of example in FIG. 2 in the turndown operating condition (decrease of the flow rate in the line through partial closure of the well head valves). It can be noted that the learning process corrects the discrepancies of the simulation method 100 bringing the error below 2% at steady state.

The main differences between simulation method 100 and method used by the reference simulator consist of the reduction of the number of segments per individual conduit (from 100 to 1) and in of the reduction of the number of layers of insulation for the thermal description (from 21 to 1).

The above description clearly illustrates the characteristics of the simulation method of the present invention, as well as its advantages.

In fact, the simulation method according to the present invention, using simplified analytical mathematical models to describe the various components of a hydrocarbons production and transport system, makes it possible to simulate in a simple and accurate manner the thermo-fluid dynamic behavior of the system.

The simplification of the present invention assures a significant performance increase in terms of calculation time, while maintaining adequate adherence to the physics of the system and sufficient reliability of the simulation.

The simplified models provided by the simulation method of the present invention comprise a set of corrective coefficients that are estimated through learning processes based on results obtained with finite volume thermo-fluid dynamic simulators or with actual measurements carried out on the field. In this way, the simulation method can be “trained” to describe the behavior of a specific geometry of the system in one or more operating regimes. Subsequently, it can be used to carry out simulations of the specific geometry of the system in other operating regimes or even partly modifying the geometry of the system, since the physics of the system is also represented in the simulation method. This technique can be extended to the simulation of the entire productive life of the system.

This type of simulation requires markedly shorter times than finite volume thermo-fluid dynamic simulators and it makes it possible to identify very rapidly potentially critical situations for flow assurance (e.g. danger of formation of waxes, hydrates, etc.).

The instrument of the patent also allows to select the situations in which it may be advisable to rely on a complete simulation for a more detailed and accurate analysis of the phenomena.

The combined use of finite volume thermo-fluid dynamic simulators and of a simulator based on the simulation method of the present invention makes it possible to reduce total simulation times and the computational burden for the analysis of a system, compared to the use of finite volume thermo-fluid dynamic simulators alone.

Lastly, it is clear that the simulation method thus conceived can be subject to numerous modifications and variations, without departing from the scope of the invention; moreover, all details can be replaced by technically equivalent elements.

1. A simulation method for simulating the thermo-fluid dynamic behavior of multiphase fluids in a hydrocarbons production and transport system, said method comprising:
outlining said hydrocarbons production and transport system as a plurality of interconnected component blocks, thus creating a schematic representation;
modeling each component block with a simplified analytical mathematical model selected from the group of models comprising at least one conduit model, a valve model, a reservoir model and a separator model, each simplified analytical mathematical model comprising a plurality of constitutive equations adapted to describe the thermo-fluid dynamic behavior of the corresponding component block;
generating an oriented graph on the basis of said schematic representation;
determining a plurality of topological equations on the basis of said oriented graph;
determining a plurality of output variables adapted to describe the thermo-fluid dynamic behavior of said system by solving the set of said plurality of topological equations and of said constitutive equations.

2. The simulation method according to claim 1, wherein said modeling further comprises:
applying a plurality of corrective coefficients to said constitutive equations for each simplified analytical mathematical model, said corrective coefficients being estimated so as to adapt the results obtained from the simplified analytical mathematical model to reference data.

3. The simulation method according to claim 2, wherein said modeling further comprises a learning operation wherein said corrective coefficients are estimated for each simplified analytical mathematical model for at least one stationary or transient flow regime through mathematical methods for minimizing the discrepancy between the data obtained from said simplified analytical mathematic model with respect to said reference data.

4. The simulation method according to claim 3, wherein said modeling further comprises a learning operation wherein said corrective coefficients are estimated for each simplified analytical mathematical model for at least one stationary or transient thermal regime through mathematical methods for minimizing the discrepancy between the data obtained from said simplified analytical mathematical model with respect to said reference data.

5. The simulation method according to claim 3, wherein said reference data are obtained from thermo-fluid dynamic finite volume simulators or through real on-field measurements.

6. The simulation method according to claim 4, wherein said reference data are obtained from thermo-fluid dynamic finite volume simulators or through real on-field measurements.
